(19) United States
(12) Patent Application Publication
(10) Pub. No.: US 2016/0237381 A1
(43) Pub. Date: Aug. 18, 2016

(54) CLEANING COMPOSITIONS CONTAINING ALKYL SULFATE SURFACTANTS AND CATIONIC POLYMER FOR HOLISTIC IMPROVEMENT OF SUDSING PROFILE

(71) Applicant: The Procter & Gamble Company, Cincinnati, OH (US)

(72) Inventors: Meng CHEN, Beijing (CN); Ming TANG, Beijing (CN); Gang SI, Beijing (CN); Yang ZHANG, San Diego, CA (US); Qi ZHANG, Beijing (CN); Aaron FLORES-FIGUEROA, Mannheim (DE)

(21) Appl. No.: 15/016,427

(22) Filed: Feb. 5, 2016

(30) Foreign Application Priority Data
Feb. 13, 2015 (WO) CN2015/072994
Dec. 4, 2015 (WO) CN2015/096390

(51) Int. Cl. C11D 3/37; C11D 1/22; C11D 1/14

(52) U.S. Cl. CPC C11D 3/3776; C11D 1/143; C11D 1/22

(57) ABSTRACT

The present invention relates to cleaning compositions containing one or more linear or branched C₆-C₁₈ alkyl sulphate surfactants with a specific chain length distribution in combination with a cationic polymer containing one or more cationic structural unit with a cationic charge density ranging from 0.05 to 10 milliequivalents/g. Such cleaning compositions exhibit surprising and unexpected improvement in the sudsing profiles and are particularly suitable for use in hand-washing fabrics.

### FIELD OF THE INVENTION

The present invention relates to cleaning compositions, more preferably liquid laundry detergent products, and most preferably liquid laundry detergent products specifically designed for hand-washing fabrics. The cleaning compositions of the present invention contain one or more alkyl sulfate surfactants in combination with a cationic polymer, which demonstrated surprising and unexpected synergistic effect in improving and optimizing the sudsing profile of the cleaning compositions in a holistic manner.

### BACKGROUND OF THE INVENTION

Sudsing profile is important for a cleaning composition, particularly laundry detergents designed for hand washing fabrics, where the appropriate volume and speed of suds formation, retention and disappearance in the wash and rinse cycles are considered key benchmarks of performance by the consumers.

Consumers viewed copious suds in the wash as the primary and most desirable signal of cleaning. High suds are especially desirable during hand washing of fabrics, since the consumer can directly feel and touch the suds generated during the wash cycle and will intuitively correlates the high suds volume with the achievement of sufficient fabric cleaning.

Paradoxically, while a large volume of suds is desirable during the wash cycle of fabric cleaning, it is nevertheless undesirable during the rinse cycle. If such high suds are still present during rinse, then the consumers immediately infer from it that there may still be surfactant residue on the fabrics and that the fabrics are not yet “clean”. As a result, the consumers feel the need to rinse the fabrics multiple times in order to make sure that the surfactants are removed as thoroughly as other soils. Because water is often a limited resource, especially in hand washing countries, the excess amount of water consumed by multiple rinses reduces the amount of water available for other possible uses, such as irrigation, drinking, bathing, etc.

Therefore, a detergent composition with a sudsing profile characterized by both high wash suds volume and low rinse suds volume is desired by consumers of hand washing habits. Such a detergent composition can generate ample suds during the wash cycle to delight the consumers but leaves little or no suds during the rinse cycle. Correspondingly, the consumer only need to rinse the fabric twice (or preferably only once to enable a “single rinse” of the fabric) for more cost saving and better environmental conservation.

WO2009/149276 discloses the use of C₈-C₁₅ alkyl sulfates, C₈-C₁₅ alkyl sulfonates, or C₈-C₁₂ alkyl benzene sulfonates to form a specific surfactant system that can improve the sudsing property of a detergent composition without compromising its cleaning properties. However, the disclosed sudsing property described by WO2009/149276 seems to be limited to higher wash suds volumes only.

WO2009/010911 discloses a high sudsing detergent composition containing a suds boosting co-surfactant in combination with a suds stabilizing surface active polymer, such as a polyvinyl acetate grafted polyethylene oxide copolymer or a hydroxylpropyl methoxyl cellulose. Examples show that such a detergent composition is capable of generating significantly higher volumes of wash suds than comparative compositions that contain either the co-surfactant alone or the surface active polymer alone, or neither. However, this high sudsing detergent composition may still suffer from undesirably high volumes of rinse suds, as more suds are carried over from the wash cycle to the rinse cycle.

Accordingly, there is a continuing need for cleaning compositions with further improved or optimized sudsing profile, characterized by both higher (or at least comparable) wash suds volume and lower rinse suds volume.

### SUMMARY OF THE INVENTION

The present invention discovers, surprisingly and unexpectedly, that a cleaning composition containing the combination of one or more linear or branched C₆-C₁₈ alkyl sulphate (“AS”) surfactants with one or more cationic polymers exhibits synergies in simultaneously increasing the wash suds volume and decreasing the rinse suds volume. Further, the cationic polymers of the present invention are not surface active polymers disclosed by WO2009/010911, so it is unexpected from the teachings of WO2009/010911 that such non-surface active cationic polymers can act together with the AS surfactants to improve the suds profile of a cleaning composition.

In one aspect, the present invention relates to a cleaning composition containing:
(a) one or more linear or branched C₆-C₁₈ alkyl sulphate (“AS”) surfactants, which contain from 80% to 100% by weight of one or more linear or branched C₆-C₁₄ AS surfactants; and
(b) one or more cationic polymers including a cationic structural unit and having a cationic charge density ranging from 0.05 to 10 milliequivalents/g.

Still another aspect of the present invention relates to the use of a cleaning composition as described hereinabove for hand-washing fabric to achieve optimized sudsing profile.

These and other features of the present invention will become apparent to one skilled in the art upon review of the following detailed description when taken in conjunction with the appended claims.

### DETAILED DESCRIPTION OF THE INVENTION

### Definitions

As used herein, the articles “a” and “an” when used in a claim, are understood to mean one or more of what is claimed or described.

As used herein, the terms “comprising,” “comprises,” “include”, “includes” and “including” are meant to be non-limiting.

As used herein, the term “substantially free of” or “substantially free from” means that the indicated material is present in an amount of no more than about 5 wt %, preferably no more than about 2%, and more preferably no more than about 1 wt %.

As used therein, the term “essentially free of” or “essentially free from” means that the indicated material is at the very minimal not deliberately added to the composition, or preferably not present at an analytically detectible level in such composition. It may include compositions in which the indicated material is present only as an impurity of one or more of the materials deliberately added to such compositions.

As used herein, the term “liquid” refers to a fluid having a liquid having a viscosity of from about 1 to about 2000 mPa*s at 25° C. and a shear rate of 20 sec-¹. In some embodiments, the viscosity of the liquid may be in the range of from about 200 to about 1000 mPa*s at 25° C. at a shear rate of 20 sec-¹. In some embodiments, the viscosity of the liquid may be in the range of from about 200 to about 500 mPa*s at 25° C. at a shear rate of 20 sec-¹.

All temperatures herein are in degrees Celsius (° C.) unless otherwise indicated. Unless otherwise specified, all measurements herein are conducted at 25° C. and under the atmospheric pressure.

As used herein the phrase “cleaning composition,” “detergent composition” or “detergent or cleaning composition” includes compositions and formulations designed for cleaning soiled material. Such compositions include but are not limited to, laundry detergent or cleaning compositions, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation. The cleaning compositions may have a form selected from liquid, powder, single-phase or multiphase unit dose, pouch, tablet, gel, paste, bar, or flake. In a preferred embodiment of the present invention, the cleaning composition of the present invention is a liquid laundry detergent composition. More preferably, the cleaning composition is in a single phase or multiphase unit dose form, e.g., a liquid laundry detergent composition that is contained in a single compartment or multi-compartment water-soluble pouch, e.g., formed by a water-soluble polymer such as poly-vinyl alcohol (PVA) or copolymers thereof.

As used herein, the term “laundry detergent” means a liquid or solid composition, and includes, unless otherwise indicated, granular or powder-form all-purpose or “heavy-duty” washing agents, especially cleaning detergents as well as cleaning auxiliaries such as bleach additives or pre-treat types. In a preferred embodiment of the present invention, the laundry detergent is a liquid laundry detergent composition.

As used herein, “suds” indicates a non-equilibrium dispersion of gas bubbles in a relatively smaller volume of a liquid. The terms like “suds”, “foam” and “lather” can be used interchangeably within the meaning of the present invention.

As used herein, “sudsing profile” refers to the properties of a cleaning composition relating to suds character during the wash and rinse cycles. The sudsing profile of a cleaning composition includes, but is not limited to, the speed of suds generation upon dissolution in the laundering liquor, the volume and retention of suds in the wash cycle, and the volume and disappearance of suds in the rinse cycle. It may further include additional suds-related parameters, such as suds stability measured during the washing cycle and the like.

As used herein, “charge density” refers to the net charge density of the polymer itself and may be different from the monomer feedstock. Charge density for a homopolymer may be calculated by dividing the number of net charges per repeating (structural) unit by the molecular weight of the repeating unit. The positive charges may be located on the backbone of the polymers and/or the side chains of polymers. For some polymers, such as those with amine structural units, the charge density depends on the pH of the carrier. For these polymers, charge density is calculated based on the charge of the monomer at pH of 7. Typically, the charge is determined with respect to the polymerized structural unit, not necessarily the parent monomer.

As used herein, the term “Cationic Charge Density” (CCD) means the amount of net positive charge present per gram of the polymer. Cationic charge density (in units of milliequivalents of charge per gram of polymer) may be calculated according to the following equation:

$$CCD = \frac{1000 \times E 2 \times C 2}{C 1 \times W 1 + C 2 \times W 2 + C 3 \times W 3}$$

where: E2 is the molar equivalents of charge of the cationic structural unit; C2 is the molar percentage of the cationic structural unit; C1 and C3 are the molar percentages of the first and second (if any) nonionic structural units; W1, W2 and W3 are the molecular weights of the first nonionic structural unit, the cationic structural unit, and the second nonionic structural unit (if any), respectively. For example, for an AAm/QVi/VP copolymer containing 80 mol % of AAm, 5 mol % of QVi, and 15 mol % of VP respectively, its cationic charge density (meq/g) is calculated as: CCD=1000×E₂×C₂/(C₁ W₁+C₂ W₂+C₃ W₃), wherein E₂=1, C₁=80, C₂=5, C₃=15, W₁=71.08, W₂=220.25 and W₃=111.14. Therefore, the cationic charge density of this copolymer is: CCD=1000×1×5/(80×71.08+5×220.25+15×111.14)=0.59.

As used herein, the term “molecular weight” refers to the weight average molecular weight of the polymer chains in a polymer composition. Further, the “weight average molecular weight” (“Mw”) may be calculated using the equation:

Mw=(ΣNiMi²)/(ΣNiMi)

where Ni is the number of molecules having a molecular weight Mi. The weight average molecular weight must be measured by the method described in the Test Methods section.

As used herein “mol %” refers to the relative molar percentage of a particular monomeric structural unit in a polymer. It is understood that within the meaning of the present invention, the relative molar percentages of all monomeric structural units that are present in the cationic polymer shall add up to 100 mol %.

As used herein, the term “derived from” refers to monomeric structural unit in a polymer that can be made from a compound or any derivative of such compound, i.e., with one or more substituents. Preferably, such structural unit is made directly from the compound in issue. For example, the term “structural unit derived from (meth)acrylamide” refers to monomeric structural unit in a polymer that can be made from (meth)acrylamide, or any derivative thereof with one or more substituents. Preferably, such structural unit is made directly from (meth)acrylamide.

As used herein, the term “(meth)acrylamide” refers to either methacrylamide or acrylamide, and it is abbreviated herein as “AAm.” Similarly, the term “meth(acrylate)” refer to either methacrylate or acrylate, and it can be abbreviated herein as “AA.”

The term “ammonium salt” or “ammonium salts” as used herein refers to various compounds selected from the group consisting of ammonium chloride, ammonium fluoride, ammonium bromide, ammonium iodine, ammonium bisulfate, ammonium alkyl sulfate, ammonium dihydrogen phosphate, ammonium hydrogen alkyl phosphate, ammonium dialkyl phosphate, and the like. For example, the diallyl dimethyl ammonium salts as described herein include, but are not limited to: diallyl dimethyl ammonium chloride (DADMAC), diallyl dimethyl ammonium fluoride, diallyl dimethyl ammonium bromide, diallyl dimethyl ammonium iodine, diallyl dimethyl ammonium bisulfate, diallyl dimethyl ammonium alkyl sulfate, diallyl dimethyl ammonium dihydrogen phosphate, diallyl dimethyl ammonium hydrogen alkyl phosphate, diallyl dimethyl ammonium dialkyl phosphate, and combinations thereof. Preferably but not necessarily, the ammonium salt is ammonium chloride.

As used herein, the term “acrylate,” “acrylates,” “methacrylate,” and “methacrylates” refers to both the acid forms as well as the salt forms of acrylic acid and methacrylic acid. Salts of acrylic acid and methacrylic acid include, but are not limited to: sodium (meth)acrylates, potassium (meth)acrylates, lithium (meth)acrylates, magnesium (meth)acrylates, calcium (meth)acrylates, aluminum (meth)acrylates, and the like. Preferably but not necessarily, the acrylate or methacrylate is sodium (meth)acrylate.

In all embodiments of the present invention, all percentages are by weight of the total composition, unless specifically stated otherwise. All ratios are weight ratios, unless specifically stated otherwise. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It is understood that the test methods that are disclosed in the Test Methods Section of the present application must be used to determine the respective values of the parameters of Applicants' inventions are described and claimed herein.

Linear or Branched C₆-C₁₈ Alkyl Sulphate (“AS”)

The cleaning composition of the present invention contains one or more linear or branched C₆-C₁₈ AS surfactants, which contain from 80% to 100% by weight of one or more linear or branched C₆-C₁₄ AS surfactants.

The AS surfactants of present invention have the general formula of R—O—SO₃⁻M⁺, wherein R is a linear or branched alkyl group having from about 6 to about 18 carbon atoms, and wherein M is a cation of alkali metal, alkaline earth metal or ammonium. Preferably, R is a linear or branched alkyl group having from about 6 to about 16 carbon atoms, more preferably from about 12 to about 16 carbon atoms. R may also contain from 0 to 3 alkoxylation units having the formula —(CₙH₂ₙO)—, but preferably R is essentially free of any of such alkoxylation units.

In a preferred but non-limiting embodiment of the present invention, the cleaning composition contains a mixture of two or more linear AS surfactants. More preferably, such a mixture includes: (1) a linear C₁₂ AS surfactant in the amount ranging from 30% to 100%, preferably from 50% to 95%, and more preferably from 65% to 80%, by total weight of the mixture; (2) a linear C₁₄ AS surfactant in the amount ranging from 0% to 70%, preferably from 5% to 50%, and more preferably from 20% to 30%, by total weight of the mixture; and (3) a linear C₁₆ AS surfactant in the amount ranging from 0% to 30%, preferably from 1% to 20%, and more preferably from 4% to 10% by total weight of the mixture. It is still more preferred that this mixture contains less than 10%, preferably less than 5%, and more preferably less than 2% of linear AS surfactants having either 18 carbon atoms or more, or 10 carbon atoms or less, by total weight of the mixture.

The linear AS surfactants of the present invention can be formed by using metathesis oils that are naturally derived, which can provide a mixture of AS surfactants with alkyl chain lengths characterized by a biologically determined distribution. For example, soybean oil, canola oil, jatropha oil, palm oil, algae oil, or the like can be co-metathesized with 3-hexene to form a mixture containing mostly C₁₂ esters. It is also preferred that algae oil of high stability with a desired fatty acid distribution, which can be produced by recombinant DNA technology as described in various patents assigned to Solazyme, is used to form the AS surfactants of the present invention. Alternatively, the above described naturally-derived oils can be co-metathesized with 3-hexene and 2-hexene to form a mixture of C₁₁, C₁₂, C₁₃ esters with a weight ratio of approximately 1:2:1. Alternatively, the above described naturally-derived oils can be co-metathesized with 3-hexene and 4-octene to form a mixture containing mainly C₁₂ and C₁₃ esters in any desired weight ratio (by controlling the 3-hexene and 4-octene mix ratio). Alternatively, the above described naturally-derived oils can be co-metathesized with a mixture containing 70 wt % 1-butene and 30 wt % hexane to form a mixture of C₁₂ and C₁₄ fatty acid esters at a weight ratio of approximately 70:30 (there will be small amount of C₁₃ and C₁₅ esters in the mixture). The esters so formed is then reduced to fatty alcohols, which is subsequently sulfated to form the AS surfactants of the present invention.

In another preferred but non-limiting embodiment of the present invention, the cleaning composition contains one or more branched C₆-C₁₈ AS surfactants having the general formula (I):

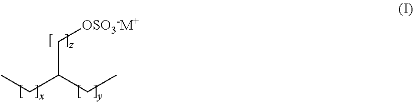

while M is a cation of alkali metal, alkaline earth metal or ammonium; x and y are independently selected from integers ranging from 0 to 14; z is an integer ranging from 1 to 4; the sum of x+y is equal to or greater than z; and the sum of x+y+z ranges from 3 to 15. Preferably, z is 1, and the sum of x+y is from 8 to 9.

Non-limiting examples of suitable branched alkyl sulphates include those having the following chemical structures:

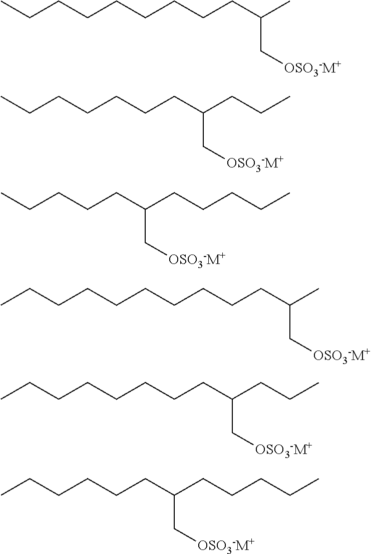

It is particularly preferred that the cleaning composition contains a mixture of two or more branched AS surfactants. More preferably, such a mixture includes: (1) a branched C₁₂ AS surfactant in the amount ranging from 20% to 80%, preferably from 30% to 70%, and more preferably from 35% to 50%, by total weight of the mixture; and (2) a branched C₁₃ AS surfactant in the amount ranging from 20% to 80%, preferably from 30% to 70%, and more preferably from 35% to 50%, by total weight of the mixture.

Even though not expressly stated, it is important to note that all the AS surfactants as described hereinabove may contain one or more alkoxylation units, which are preferably, but not necessarily, ethoxylation units. Preferably, the AS surfactants have a weight average degree of alkoxylation (preferably ethoxylation) ranging from 0 to 3. More preferably, the AS surfactant of the present invention is substantially free of alkoxylation units. Most preferably, the AS surfactant of the present invention is essentially free of alkoxylation units, i.e., they are unalkoxylated.

Branched alkyl sulfates are commercially available as a mixture of linear isomer and branched isomer with a variety of chain lengths, degrees of ethoxylation and degrees of branching. Such as Empimin® KSL68/A and Empimin® KSN70/LA by Albright & Wilson with C₁₂₋₁₃ chain length distribution, about 60% branching and having an average ethoxylation of 1 and 3, Dobanol® 23 ethoxylated sulphates from Shell with C₁₂₋₁₃ chain length distribution, about 18% branching and having an average ethoxylation of 0.1 to 3, sulphated Lial® 123 ethoxylates from Condea Augusta with C₁₂₋₁₃ chain length distribution, about 60% branching and an average ethoxylation of 0.1 to 3 and sulphated Isalchem® 123 with C₁₂₋₁₃ chain length distribution and about 95% branching.

The one or more linear or branched C₆-C₁₈ AS surfactants as described hereinabove can be present in an amount ranging from 0.1% to 30%, preferably from 0.5% to 20%, and more preferably from 1% to 10%, by total weight of the cleaning composition.

### Cationic Polymer

The cleaning composition of the present invention also includes one or more cationic polymers containing a cationic structural unit and having a cationic charge density ranging from 0.05 to 10 milliequivalents/g. If the cationic charge density of the cationic polymer is sufficiently high, e.g., higher than 5 milliequivalents/g, formulation of such a polymer into a cleaning composition containing high amounts of anionic surfactants may be difficult due to coacervate formed therebetween and the likelihood of observable precipitates in the formulation. Therefore, it is preferred that the cationic charge density of the cationic polymer ranges from 0.1 to 5 milliequivalents/g, more preferably from 0.3 to 4 milliequivalents/g, and most preferably from 0.6 to 3 milliequivalents/g.

The cationic structural unit of the above-described cationic polymer can be derived from a monomer selected from the group consisting of diallyl dimethyl ammonium salts (“DADMAS”), N,N-dimethyl aminoethyl acrylate, N,N-dimethyl aminoethyl methacrylate (“DMAM”), [2-(methacryloylamino)ethyl]tri-methylammonium salts, N,N-dimethylaminopropyl acrylamide (DMAPA), N,N-dimethylaminopropyl methacrylamide (“DMAPMA”), acrylamidopropyl trimethyl ammonium salts (“APTAS”), methacrylamidopropyl trimethylammonium salts (“MAPTAS”), quaternized vinylimidazole (“QVi”), and combinations thereof.

Preferably, the cationic structural unit is derived from DADMAS as described hereinabove. Alternatively, the cationic structural unit can be derived from a [2-(methacryloylamino)ethyl]tri-methylammonium salt, such as, for example, [2-(methacryloylamino)ethyl]tri-methylammonium chloride, [2-(methacryloylamino)ethyl]tri-methylammonium fluoride, [2-(methacryloylamino)ethyl]tri-methylammonium bromide, [2-(methacryloylamino)ethyl]tri-methylammonium iodine, [2-(methacryloylamino)ethyl]tri-methylammonium bisulfate, [2-(methacryloylamino)ethyl]tri-methylammonium alkyl sulfate, [2-(methacryloylamino)ethyl]tri-methylammonium dihydrogen phosphate, [2-(methacryloylamino)ethyl]tri-methylammonium hydrogen alkyl phosphate, [2-(methacryloylamino)ethyl]tri-methylammonium dialkyl phosphate, and combinations thereof. Further, the cationic structural unit can be derived from APTAS, which include, for example, acrylamidopropyl trimethyl ammonium chloride (APTAC), acrylamidopropyl trimethyl ammonium fluoride, acrylamidopropyl trimethyl ammonium bromide, acrylamidopropyl trimethyl ammonium iodine, acrylamidopropyl trimethyl ammonium bisulfate, acrylamidopropyl trimethyl ammonium alkyl sulfate, acrylamidopropyl trimethyl ammonium dihydrogen phosphate, acrylamidopropyl trimethyl ammonium hydrogen alkyl phosphate, acrylamidopropyl trimethyl ammonium dialkyl phosphate, and combinations thereof. Still further, the cationic structural unit can be derived from a MAPTAS, which includes, for example, methacrylamidopropyl trimethylammonium chloride (MAPTAC), methacrylamidopropyl trimethylammonium fluoride, methacrylamidopropyl trimethylammonium bromide, methacrylamidopropyl trimethylammonium iodine, methacrylamidopropyl trimethylammonium bisulfate, methacrylamidopropyl trimethylammonium alkyl sulfate, methacrylamidopropyl trimethylammonium dihydrogen phosphate, methacrylamidopropyl trimethylammonium hydrogen alkyl phosphate, methacrylamidopropyl trimethylammonium dialkyl phosphate, and combinations thereof.

More preferably, the cationic structural unit is derived from DADMAC, MAPTAC, APTAC, or QVi. Most preferably, the cationic structural unit is made directly from DADMAC.

The cationic polymer may contain from 1 mol % to 100 mol %, preferably from 5 mol % to 100 mol %, more preferably from 5 mol % to 60 mol %, and most preferably from 5 mol % to 20 mol %, of the cationic structural unit.

The cationic polymer used in the present invention can be a homopolymers containing only the cationic structural unit as described hereinabove (i.e., at 100 mol %), or it can be a copolymer that contains the cationic structural unit and one or more other structural units. The cationic structural unit and said one or more other structural units can be incorporated into the cationic polymer in a random format or can be in a blocky format, to form random copolymers or blocky copolymers.

For example, the cationic polymer may also comprise a first nonionic structural unit derived from (meth)acrylamide (“AAm”). This first nonionic structural unit may be present in the cationic polymer in an amount ranging from 0 mol % to 99 mol %, preferably from 10 mol % to 95 mol %, and more preferably from 15 mol % to 90 mol %.

In a particularly preferred embodiment of the present invention, such cationic polymer is a copolymer that contains only the cationic structural unit and the first nonionic structural unit as described hereinabove, i.e., it is substantially free of any other structural components, either in the polymeric backbone or in the side chains. For example, the cationic polymer may consist essentially of: (i) from about 5 mol % to about 40 mol %, and preferably from about 10 mol % to about 35 mol %, of the cationic structural unit as described hereinabove; and (ii) from about 60 mol % to about 95 mol %, and preferably from about 65 mol % to about 90 mol %, of the AAm-derived first nonionic structural unit.

In another preferred embodiment of the present invention, such cationic polymer is a terpolymer that further comprises a second nonionic structural unit derived from a monomer selected from the group consisting of vinylpyrrolidone (“VP”), vinyl acetate, vinyl alcohol, vinyl formamide, vinyl acetamide, vinyl alkyl ether, vinyl pyridine, vinyl imidazole, vinyl caprolactam, and combinations thereof. The second nonionic structural unit is preferably VP. The second nonionic structural unit may be present in the cationic polymer in an amount ranging from 0 mol % to 50 mol %, preferably from 0 mol % to 30 mol %, and more preferably from 5 mol % to 25 mol %.

Preferably but not necessarily, the cationic polymer of the present invention is a terpolymer that contains only the cationic structure unit and the first and second nonionic structural units as described hereinabove, and it is substantially free of any other structural components. For example, the cationic polymer may consist essentially of: (i) from about 5 mol % to about 40 mol %, and preferably from about 10 mol % to about 35 mol %, of the cationic structural unit as described hereinabove; (ii) from about 60 mol % to about 95 mol %, and preferably from about 65 mol % to about 90 mol %, of the first nonionic AAm-derived structural unit as described hereinabove; (iii) from about 0.1 mol % to about 86 mol %, and preferably from about 3 mol % to about 60 mol %, of the second nonionic structural unit as described hereinabove.

Alternatively, the cationic polymer of the present invention can include one or more additional structural units besides those described hereinabove.

The preferred molar percentage ranges as specified hereinabove may help to further improve the sudsing profile generated by the laundry detergent compositions containing such cationic polymer during the wash and rinse cycles.

Molecular weights of the cationic polymers may also be modulated to help improving sudsing profile. Further, by modulating or controlling the molecular weights of the cationic polymers of the present invention, the whiteness loss that is commonly seen in fabrics after they have been exposed to multiple washes can be reduced or minimized Cationic polymers have been known to contribute to fabric whiteness loss, which is a limiting factor for wider usage of such polymers. However, inventors of the present invention have discovered that by controlling the molecular weight of the cationic polymer within a specific range, i.e., wherein said one or more cationic polymers have a weight average molecular weight (Mw) ranging from about 10,000 to about 3,000,000 Daltons, preferably from about 20,000 to about 2,000,000 Daltons, more preferably from about 30,000 to about 1,500,000 Daltons, and most preferably from about 40,000 to about 200,000 Daltons, the fabric whiteness loss can be effectively reduced in comparison with conventional cationic polymers.

The cationic polymer can be present in the cleaning composition of the present invention in an amount ranging from 0.01% to 20%, preferably from 0.05% to 10%, more preferably from 0.1% to 5%, and most preferably from 0.2% to 4% by total weight of the cleaning composition.

### Cleaning Composition

The cleaning composition of the present invention can be hard surface cleaners, such as for example, dish washing detergents, and those used in the health and beauty areas, including shampoos and soaps, which may benefit from products having improved sudsing profiles. In another aspect, the cleaning composition is suitable for laundry detergent application, for example: laundry, including automatic washing machine laundering or hand-washing, or cleaning auxiliaries, such as for example, bleach, rinse aids, additives or pre-treat types.

The cleaning compositions can be in any form, namely, in the form of a liquid; a solid such as a powder, granules, agglomerate, paste, tablet, pouches, bar, gel; an emulsion; types delivered in dual- or multi-compartment containers or pouches; a spray or foam detergent; premoistened wipes (i.e., the cleaning composition in combination with a nonwoven material); dry wipes (i.e., the cleaning composition in combination with a nonwoven materials) activated with water by a consumer; and other homogeneous or multiphase consumer cleaning product forms.

Preferably, the cleaning composition is a laundry detergent composition, and more preferably a liquid laundry detergent, that is a fully formulated laundry detergent product. Liquid compositions contained in encapsulated and/or unitized dose products are included, as are compositions which comprise two or more separate but jointly dispensable portions. More preferably, the laundry detergent composition is a liquid laundry detergent composition designed for hand-washing, where the improved suds benefit or superior sudsing profile is most evident to the consumer. The liquid laundry detergent composition preferably contains water as an aqueous carrier, and it can contain either water alone or mixtures of organic solvent(s) with water as carrier(s). Suitable organic solvents are linear or branched lower C₁-C₈ alcohols, diols, glycerols or glycols; lower amine solvents such as C₁-C₄ alkanolamines, and mixtures thereof. Exemplary organic solvents include 1,2-propanediol, ethanol, glycerol, monoethanolamine and triethanolamine. The carriers are typically present in a liquid composition at levels in the range of from about 0.1% to about 98%, preferably from about 10% to about 95%, more preferably from about 25% to about 75% by total weight of the liquid composition. In some embodiments, water is from about 85 to about 100 wt % of the carrier. In other embodiments, water is absent and the composition is anhydrous. Highly preferred compositions afforded by the present invention are clear, isotropic liquids.

The liquid laundry detergent composition of the present invention has a viscosity from about 1 to about 2000 centipoise (1-2000 mPa·s), or from about 200 to about 800 centipoises (200-800 mPa·s). The viscosity can be determined using a Brookfield viscometer, No. 2 spindle, at 60 RPM/s, measured at 25° C.

In addition to the AS surfactants described hereinabove, the cleaning compositions of the present invention may comprise one or more additional surfactants at amounts ranging from about 1% to about 90%, more preferably from about 1% to about 50%, and more preferably from about 5% to about 30% by total weight of the compositions. Detersive surfactants utilized can be of the anionic, nonionic, cationic, amphoteric, or type or can comprise compatible mixtures of these types.

Anionic and nonionic surfactants are preferred. Useful anionic surfactants can themselves be of several different types. For example, water-soluble salts of the higher fatty acids, i.e., “soaps”, are useful anionic surfactants in the compositions herein. This includes alkali metal soaps such as the sodium, potassium, ammonium, and alkyl ammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap. Additional non-soap anionic surfactants which are suitable for use herein include the water-soluble salts, preferably the alkali metal, and ammonium salts, of organic sulfuric reaction products having in their molecular structure an alkyl group (included in the term “alkyl” is the alkyl portion of acyl groups) containing from about 10 to about 20 carbon atoms and a sulfonic acid or sulfuric acid ester group. Examples of this group of synthetic anionic surfactants include, but are not limited to: a) the sodium, potassium and ammonium alkyl sulfates with either linear or branched carbon chains, especially those obtained by sulfating the higher alcohols (C₁₀-C₂₀ carbon atoms), such as those produced by reducing the glycerides of tallow or coconut oil; b) the sodium, potassium and ammonium alkylethoxy sulfates with either linear or branched carbon chains, particularly those in which the alkyl group contains from about 10 to about 20, preferably from about 12 to about 18 carbon atoms, and wherein the ethoxylated chain has, in average, a degree of ethoxylation ranging from about 0.1 to about 5, preferably from about 0.3 to about 4, and more preferably from about 0.5 to about 3; c) the sodium and potassium alkyl benzene sulfonates in which the alkyl group contains from about 10 to about 20 carbon atoms in either a linear or a branched carbon chain configuration, preferably a linear carbon chain configuration; d) the sodium, potassium and ammonium alkyl sulphonates in which the alkyl group contains from about 10 to about 20 carbon atoms in either a linear or a branched configuration; e) the sodium, potassium and ammonium alkyl phosphates or phosphonates in which the alkyl group contains from about 10 to about 20 carbon atoms in either a linear or a branched configuration, f) the sodium, potassium and ammonium alkyl carboxylates in which the alkyl group contains from about 10 to about 20 carbon atoms in either a linear or a branched configuration, and combinations thereof. Especially preferred for the practice of the present invention are surfactant systems containing C₁₀-C₂₀ linear alkyl benzene sulphonates, C₁₀-C₂₀ linear or branched alkylethoxy sulfates having an average degree of ethoxylation ranging from 0.1 to about 5 (preferably from about 0.3 to about 4 and more preferably from about 0.5 to about 3, which is particularly advantageous for improving the sudsing profile of the detergent composition), or mixtures thereof. The anionic surfactants can be provided in the cleaning compositions of the present invention at levels ranging from 1% to about 90%, more preferably from about 1% to about 50%, and more preferably from about 5% to about 30% by total weight of the compositions.

Preferred nonionic surfactants are those of the formula R¹(OC₂H₄)ₙOH, wherein R¹ is a C₈-C₁₈ alkyl group or alkyl phenyl group, and n is from about 1 to about 80. Particularly preferred are C₈-C₁₈ alkyl alkoxylated alcohols having an average degree of alkoxylation from 1 to 20. The nonionic surfactants can be provided in the cleaning compositions at levels ranging from 0.05 wt % to 10 wt %, preferably from 0.1 wt % to 10 wt %, and more preferably from 1 wt % to 10 wt %.

In a particularly preferred embodiment of the present invention, the cleaning composition further comprises: (1) from 1% to 90% by weight of one or more anionic surfactants selected from the group consisting of C₁₀-C₂₀ linear alkyl benzene sulphonates, C₁₀-C₂₀ linear or branched alkylalkoxy sulfates having an average degree of alkoxylation ranging from 0.1 to 5.0, C₁₀-C₂₀ linear or branched alkyl sulphonates, C₁₀-C₂₀ linear or branched alkyl phosphates, C₁₀-C₂₀ linear or branched alkyl phosphonates, C₁₀-C₂₀ linear or branched alkyl carboxylates, and combinations thereof; and (2) optionally, from 0.05% to 10% by weight of one or more nonionic surfactants selected from the group consisting of C₈-C₁₈ alkyl alkoxylated alcohols having a weight average degree of alkoxylation ranging from 1 to 20 and combinations thereof.

Other surfactants useful herein include amphoteric surfactants and cationic surfactants. Such surfactants are well known for use in laundry detergents and are typically present at levels from about 0.2 wt % or 1 wt % to about 40 wt % or 50 wt %.

The cleaning composition of the present invention can be either a granular or a liquid laundry detergent composition, and preferably it is the latter.

In a particularly preferred embodiment, the cleaning composition is a liquid laundry detergent composition containing: (a) from 0.5% to 5% of a linear C₁₂ AS surfactant; (b) from 0.1% to 2% of a linear C₁₄ AS surfactant; (c) from 0.05% to 1% of a linear C₁₆ AS surfactant; (d) from 0.1% to 2% by weight of a cationic polymer which is a copolymer or terpolymer containing a first cationic structural unit derived from DADMAC, MAPTAC, APTAC or QVi, a second nonionic structural unit derived from AAm, and optionally a third nonionic structural unit derived from VP; (e) from 5% to 20% by weight of C₁₀-C₂₀ linear alkyl benzene sulphonates; and (f) from 1% to 10% by weight of C₁₀-C₁₄ alkyl alkoxylated alcohols having a weight average degree of alkoxylation ranging from 5 to 10 and combinations thereof.

Alternatively, the cleaning composition is a liquid laundry detergent composition that includes: (a) from 0.5% to 5% of a branched C₁₂ AS surfactant; (b) from 0.5% to 5% of a branched C13 AS surfactant; and (c) from 0.1% to 2% by weight of a cationic polymer which is a copolymer or terpolymer containing a first cationic structural unit derived from DADMAC, MAPTAC, APTAC or QVi, a second nonionic structural unit derived from AAm, and optionally a third nonionic structural unit derived from VP; (d) from 5% to 20% by weight of C₁₀-C₂₀ linear alkyl benzene sulphonates; and (e) from 1% to 10% by weight of C₁₀-C₁₄ alkyl alkoxylated alcohols having a weight average degree of alkoxylation ranging from 5 to 10 and combinations thereof.

In both liquid laundry detergent compositions described hereinabove, it is preferred that the cationic polymer contains from 5 mol % to 60 mol % of the cationic structural unit, from 15 mol % to 80 mol % of the first nonionic structural unit, and from 0 mol % to 25 mol % of the second nonionic structural unit. It is also preferred that the AS surfactants herein are substantially free of, and more preferably essentially free of, alkoxylation.

The liquid laundry detergent composition may also contain an external structurant, which may be present in an amount ranging from about 0.001% to about 1.0%, preferably from about 0.05% to about 0.5%, more preferably from about 0.1% to about 0.3% by total weight of the composition. Suitable external structurants include those described, for example, in US2007/169741 and US2005/0203213. A particularly preferred external structurant for the practice of the present invention is hydrogenated castor oil, which is also referred to as trihydroxylstearin and is commercially available under the tradename Thixin®.

In yet another preferred embodiment of the present invention, the liquid laundry detergent composition further contains from about 0.1 wt % to 5 wt %, preferably from 0.5 wt % to 3 wt %, more preferably from 1 wt % to 1.5 wt %, of one or more fatty acids and/or alkali salts thereof. Suitable fatty acids and/or salts that can be used in the present invention include C₁₀-C₂₂ fatty acids or alkali salts thereof. Such alkali salts include monovalent or divalent alkali metal salts like sodium, potassium, lithium and/or magnesium salts as well as the ammonium and/or alkylammonium salts of fatty acids, preferably the sodium salt.

In addition to the above-described ingredients, the liquid laundry detergent compositions of the present invention may comprise one or more builders. Examples of suitable builders include water-soluble alkali metal phosphates, polyphosphates, borates, citrates, and silicates; water-soluble amino polycarboxylates; water-soluble salts of phytic acid; polycarboxylates; zeolites or aluminosilicates and combinations thereof. Specific examples of these are: sodium and potassium triphosphates, pyrophosphates, orthophosphates, hexametaphosphates, tetraborates, and silicates; water-soluble salts of mellitic acid, carboxymethyloxysuccinic acid, salts of polymers of itaconic acid and maleic acid, tartrate monosuccinate, tartrate disuccinate. It may also be especially preferred for the laundry detergent powder to comprise low levels, or even be essentially free, of builder. The term “essentially free” means that the composition “comprises no deliberately added” amount of that ingredient. In a preferred embodiment, the liquid laundry detergent composition of the present invention comprises no builder.

In a preferred embodiment of the present invention, the liquid laundry detergent composition comprises from about 0.1 wt % to about 10 wt % of citric acid and/or boric acid as pH buffers. For example, citric acid may be provided in the amount ranging from about 1 wt % to about 5 wt %, and boric acid may be provided in the amount ranging from about 1 wt % to about 3 wt %.

The balance of the liquid detergent composition typically contains one or more adjunct ingredients. Suitable adjunct ingredients include but are not limited to: builders, chelating agents, dye transfer inhibiting agents, dispersants, rheology modifiers, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, structure elasticizing agents, fabric softeners, carriers, hydrotropes (e.g., sodium cumene sulphonate or NaCS), processing aids, solvents, hueing agents, anti-microbial agents, free perfume oils, and/or pigments. In addition to the disclosure below, suitable examples of such other adjunct ingredients and levels of use are found in U.S. Pat. Nos. 5,576,282, 6,306,812, and 6,326,348. The precise nature of these adjunct ingredients and the levels thereof in the liquid laundry detergent composition will depend on factors like the specific type of the composition and the nature of the cleaning operation for which it is to be used.

In a particularly preferred embodiment, the liquid detergent composition herein comprises a rheology modifier (also referred to as a “structurant” in certain situations), which functions to suspend and stabilize the microcapsules and to adjust the viscosity of the composition so as to be more applicable to the packaging assembly. The rheology modifier herein can be any known ingredient that is capable of suspending particles and/or adjusting rheology to a liquid composition, such as those disclosed in U.S. Patent Application Nos. 2006/0205631A1, 2005/0203213A1, and U.S. Pat. Nos. 7,294,611, 6,855,680. Preferably, the rheology modifier is selected from the group consisting of hydroxy-containing crystalline material, polyacrylate, polysaccharide, polycarboxylate, amine oxide, alkali metal salt, alkaline earth metal salt, ammonium salt, alkanolammonium salt, C₁₂-C₂₀ fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof.

### Method of Making the Cleaning Composition

Incorporation of the above-described components and various other ingredients as described hereinabove into the detergent or cleaning compositions of the invention can be done in any suitable manner and can, in general, involve any order of mixing or addition.

For example, the AS surfactants can be mixed first with one or more of the other ingredients and then mixed with the cationic polymer, followed by yet another mixing step with other ingredients to form the final cleaning composition. Alternatively, the cationic polymer can be mixed first with one or more of the other ingredients and then mixed with the AS surfactants, followed by another mixing step with other ingredients to form the final cleaning composition. Still further, the AS surfactants and the cationic polymer can be simultaneously mixed with the other ingredients to form the final cleaning composition in one mixing step. In yet another example, the cationic polymer can be premixed with an emulsifier, a dispersing agent or a suspension agent to form an emulsion, a latex, a dispersion, a suspension, and the like, which is then mixed with the AS surfactants, followed by yet another mixing step with other components to form the final cleaning composition. These components can be added in any order and at any point in the process of preparing the final composition.

### Methods of Using the Laundry Detergent Composition

The present invention is directed to a method of cleaning fabric, the method comprising the steps of: (i) providing a laundry detergent composition as described above; (ii) forming a laundry liquor by diluting the laundry detergent composition with water; (iii) washing fabric in the laundry liquor; and (iv) rinsing the fabric in water, wherein after 2 or less rinses, preferably after 1 rinse, the laundry liquor is substantially free of suds, or at least 75%, preferably at least 85%, more preferably 95%, and even more preferably at least 99% of a surface area of the laundry liquor is free from suds.

The present invention is also directed to a method of saving water during laundering, the method comprising the steps of: (i) providing a laundry detergent as described above; (ii) diluting the cleaning composition with wash water in a container to form a laundry liquor; (iii) washing laundry in the laundry liquor; and (iv) rinsing the laundry, wherein after no more than two rinses, preferably after no more than on rinse, the laundry liquor is substantially free of suds.

The method of laundering fabric may be carried out in a top-loading or front-loading automatic washing machine, or can be used in a hand-wash laundry application, which is particularly preferred in the present invention.

### Test Methods

Various techniques are known in the art to determine the properties of the compositions of the present invention comprising the cationic polymer. However, the following assays must be used in order that the invention described and claimed herein may be fully understood.

### Test 1: Quantification of the Monomers by HPLC

Each of the monomers in the cationic polymer are quantified by high pressure liquid chromatography (HPLC) according to the follows:

| | |
|---|---|
| Measuring device: | L-7000 series (Hitachi Ltd.) |
| Detector: | UV detector, L-7400 (Hitachi Ltd.) |
| Column: | SHODEX RSpak DE-413 |
| | (product of Showa Denko K. K.) |
| Temperature: | 40° C. |
| Eluent: | 0.1% phosphoric acid aqueous solution |
| Flow Velocity: | 1.0 mL/min |

### Test 2: Measurement of Weight Average Molecular Weight (Mw)

The weight-average molecular weight (Mw) of a polymer material of the present invention is determined by Size Exclusion Chromatography (SEC) with differential refractive index detection (RI). One suitable instrument is Agilent® GPC-MDS System using Agilent® GPC/SEC software, Version1.2 (Agilent, Santa Clara, USA). SEC separation is carried out using three hydrophilic hydroxylation polymethyl methacrylate gel columns (Ultrahydrogel 2000-250-120 manufactured by Waters, Milford, USA) directly joined to each other in a linear series and a solution of 0.1M sodium chloride and 0.3% trifluoroacetic acid in DI-water, which is filtered through 0.22 μm pore size GVWP membrane filter (MILLIPORE, Massachusetts, USA). The RI detector needs to be kept at a constant temperature of about 5-10° C. above the ambient temperature to avoid baseline drift. It is set to 35° C. The injection volume for the SEC is 100 lit. Flow rate is set to 0.8 ml/min. Calculations and calibrations for the test polymer measurements are conducted against a set of 10 narrowly distributed Poly(2-vinylpyridin) standards from Polymer Standard Service (PSS, Mainz Germany) with peak molecular weights of: Mp=1110 g/mol; Mp=3140 g/mol; Mp=4810 g/mol; Mp=11.5 k g/mol; Mp=22 k g/mol; Mp=42.8 k g/mol; Mp=118 k g/mol; Mp=256 k g/mol; Mp=446 k g/mol; and Mp=1060 k g/mol.

Each test sample is prepared by dissolving the concentrated polymer solution into the above-described solution of 0.1M sodium chloride and 0.3% trifluoroacetic acid in DI water, to yield a test sample having a polymer concentration of 1 to 2 mg/mL. The sample solution is allowed to stand for 12 hours to fully dissolve, and then stirred well and filtered through a 0.45 μm pore size nylon membrane (manufactured by WHATMAN, UK) into an auto sampler vial using a 5 mL syringe. Samples of the polymer standards are prepared in a similar manner. Two sample solutions are prepared for each test polymer. Each solution is measured once. The two measurement results are averaged to calculate the Mw of the test polymer.

For each measurement, the solution of 0.1M sodium chloride and 0.3% trifluoroacetic acid in DI water is first injected onto the column as the background. A correction sample (a solution of 1 mg/mL polyethylene oxide with Mp=111.3 k g/mol) is analysed six times prior to other sample measurements, so as to verify repeatability and accuracy of the system.

The weight-average molecular weight (Mw) of the test sample polymer is calculated using the software that accompanies the instrument and selecting the menu options appropriate for narrow standard calibration modelling. A third-order polynomial curve is used to fit the calibration curve to the data points measured from the Poly(2-vinylpyridin) standards. The data regions used for calculating the weight-average molecular weight are selected based upon the strength of the signals detected by the RI detector. Data regions where the RI signals are greater than 3 times the respective baseline noise levels are selected and included in the Mw calculations. All other data regions are discarded and excluded from the Mw calculations. For those regions which fall outside of the calibration range, the calibration curve is extrapolated for the Mw calculation.

To measure the average molecular weight of a test sample containing a mixture of polymers of different molecular weights, the selected data region is cut into a number of equally spaced slices. The height or Y-value of each slice from the selected region represents the abundance (Ni) of a specific polymer (i), and the X-value of each slice from the selected region represents the molecular weight (Mi) of the specific polymer (i). The weight average molecular weight (Mw) of the test sample is then calculated based on the equation described hereinabove, i.e., Mw=(ΣNi Mi2)/(ΣNi Mi).

### Test 3: Sudsing Profile Test

The sudsing profile of the detergent composition herein is measured by employing a suds cylinder tester (SCT). The SCT has a set of 8 cylinders. Each cylinder is typically 66 cm long and 50 mm in diameter and may be together rotated at a rate of 20-22 revolutions per minute (rpm). This method is used to assay the performance of laundry detergent to obtain a reading on ability to generate suds as well as its suds stability and rinse suds performance. The following factors affect results and therefore should be controlled properly: (a) concentration of detergent in solution, (b) water hardness, (c) water temperature, (d) speed and number of revolutions, (e) soil load in the solution, and (f) cleanliness of the inner part of the tubes.

The performance is determined by comparing the suds height generated during the washing stage by the laundry detergent containing the foam control composition versus a laundry detergent without the foam control composition (i.e., control). The amount of suds present for the detergent alone and the detergent with the foam control composition is measured by recording the total suds height (i.e., height of suds plus wash liquor) minus the height of the wash liquor alone.
1. Weigh 1.5 grams product and dissolve it in 300 ml of city water with a water hardness of about 16 gpg for at least 15 min to form a solution containing the test product at about 5000 ppm. Dissolve the samples simultaneously.
2. Pour the sample aliquot to the tubes. Put in the rubber stopper and lock the tubes in place.
3. Spin for 10 revolutions. Lock in an upright position. Wait 1 min and check the suds height very quickly (˜10 sec) left to right. Record the total suds height (i.e., height of the suds plus wash liquor) and the height of the wash liquor alone. This marks the after 10 revolutions data.
4. Spin for additional 20 revolutions. This marks the after 30 revolutions data. Take recordings from left to right.
5. Spin for 20 revolutions more. This marks the after 50 revolutions data. Take readings from left to right. Repeat this step one more time; thus, the data gathered are for after 70 revolutions.
6. Open the tubes. Add 1 piece of fabric stained with clay and ¼ piece of fabric stained with dirty cooking oil (DCO) into each tube. Put in the rubber stopper. Spin for 20 revolutions. This marks the after 90 revolutions data. Take readings. Repeat this step one time; thus, the data gathered are for after 110 revolutions.
   The addition of the artificial soil is intended to mimic the real world washing conditions where more soils dissolve into the wash liquor from the fabrics being wash. Therefore, this test is relevant for determining the initial sudsing profile of a composition and its sudsing profile in a washing cycle.
   (Note: Preparation of fabric stained with clay is conducted as follows:
      Disperse 20 g of Beijing-clay (clay collected from 15 cm below the earth surface in Beijing, China) into 80 ml of DI water via agitation to make a clay suspension.
      Keep agitating the suspension during the preparation process, while brushing 2 g of such clay suspension onto the center of a 10 cm*10 cm cotton fabric to form a round shape stain (d=5 cm).
      The cotton fabric stained with clay is left dry at room temperature and then used for the performance evaluation.
   Preparation of fabric stained with DCO is conducted as follows:
      100 grams of peanut oil is used to fry 20 grams of salty fish for 2 hrs at 150-180° C. to form the DCO.
      Brush 0.6 ml of the DCO onto the center of a 10 cm*10 cm cotton fabric to form a round shape stain (d=5 cm).
      Cut the 10 cm*10 cm cotton fabric into 4 equal pieces and use one for the performance evaluation.)
7. Pour 37.5 mL solution out of the tube gently into 300 mL beaker. Add 262.5 ml city water into the beaker to make a total of 300 ml ⅛ diluted solution. Dispose of the remaining solution and wash the tube with tap water. Pour the 300 mL solution into the same tube.
8. Spin for 20 revolutions. This marks the after 130 revolutions data. Take readings from left to right. Repeat this step one time; thus data gathered are for after 150 revolutions.
9. Pour 150 mL solution out of the tube gently into 300 mL beaker. Add 150 ml city water into the beaker to make a total of 300 ml 1/16 diluted solution. Dispose of the remaining solution and wash the tube with tap water. Pour the 300 mL solution into the same tube. Repeat steps 8. Data gathered are for 190 revolutions data.
10. In a typical sudsing profile test, Steps 1-9 are repeated at least once to ensure the test repeatability.
11. Data analysis: Breakdown of the suds category

| | | | |
|---|---|---|---|
| Flash Suds | 10 | revolutions data | Flash Suds |
| Suds | 30-70 | revolutions data | Washing Cycle: Wash data |
| Generation | | | analysis is focused on Suds |
| Suds Stability | 90-110 | revolutions data | stability |
| ⅛ Rinse (First | 130-150 | revolutions data | Rinsing Cycle: Rinse data |
| Rinse) | | | analysis is focused on ⅛ |
| | | | Rinse |
| 1/16 Rinse | 170-190 | revolutions data | Rinsing Cycle: 1/16 Rinse |
| (Second Rinse) | | | |

### EXAMPLES

### Example 1

### Exemplary Cationic Polymers

The following inventive cationic polymers (A)-(H) are provided for formulating the cleaning compositions of the present invention:

TALBE I

| | | | | | | Calculated |
|---|---|---|---|---|---|---|
| | | | | | | Charge |
| Inventive | | AAm | Cationic | VP | Mw | Density |
| Polymers | Monomer Compositions | (mol %) | (mol %) | (mol %) | (K Dalton) | (meq/g) |
| A | AAm/QVI/VP | 80 | 5 | 15 | 373.2 | 0.59 |
| B | AAm/MAPTAC/VP | 80 | 5 | 15 | 567.3 | 0.59 |
| C | AAm/APTAC/VP | 80 | 5 | 15 | 1123.6 | 0.60 |
| D | AAm/DADMAC | 87 | 13 | — | 102.7 | 1.57 |
| E | AAm/DADMAC/VP | 80 | 16 | 4 | 165.3 | 1.84 |
| F | AAm/DADMAC/VP | 40 | 37 | 23 | 161.9 | 3.25 |
| G | AAm/DADMAC/VP | 19 | 57 | 24 | 48.2 | 4.31 |
| H | AAm/DADMAC | 30 | 70 | — | 84.8 | 5.20 |

### Example 2

### Linear Unalkoxylated as Surfactant Mixture

A mixture of linear unalkoxylated AS surfactants is provided, which contains the following components:

| Linear AS | |
|---|---|
| (Alkyl Chain Length) | Weight % |
| C12 | 71 |
| C14 | 23 |
| C16 | 5 |
| >=C18 & <=C10 | 0.1 |

### Example 3

### Branched Unalkoxylated as Surfactant Mixture

A mixture of branched unalkoxylated AS surfactants is provided, and it contains the following components:

| Branched AS | |
|---|---|
| (Alkyl Chain Length) | Weight % |
| C12 | >40 |
| C13 | >40 |

The C₁₂ and C₁₃ AS surfactants in this mixture is at least 90% branched (with the branched side chain randomly distributed along the main carbon chain) and have the following formula:

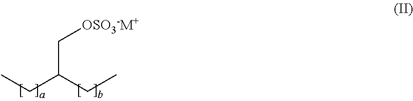

wherein M is a cation of alkali metal, alkaline earth metal or ammonium, and a+b is 8 or 9.

### Example 4

### Synergistically Improved Sudsing Profile Achieved by Linear or Branched as Surfactants and Cationic Polymers

A base liquid laundry detergent formulation containing the following ingredients is first provided:

TABLE II

| Ingredients | (wt %) |
|---|---|
| HLAS | 9.00 |
| C₁₂-C₁₄ alkyl 7-ethoxylate | 4.00 |
| Citric acid | 2.00 |
| Boric acid | 2.10 |
| 1,2 propanediol | 1.21 |
| NaCS | 1.00 |
| NaOH | 1.50 |
| Water | Balance |
| Total: | 100.000 |

Various sample or test compositions are prepared, which include: (1) a control composition, which contains only the base liquid laundry detergent formulation, with neither AS surfactants nor cationic polymer; (2) various comparative compositions, containing 3 wt % of the linear unalkoxylated AS surfactant mixture described in Example 2 hereinabove alone, or 3 wt % of the branched unalkoxylated AS surfactant mixture described in Example 3 hereinabove alone, without any cationic polymer; (3) various comparative compositions, containing 0.5 wt % of one of the cationic polymers (A)-(H) described in Example 1 hereinabove alone, without the AS surfactants; and (4) various inventive compositions, which contain 3 wt % of the linear or branched unalkoxylated AS surfactant mixture described in Example 2 or 3 hereinabove in combination with 0.5 wt % of one of the cationic polymers (A)-(H) described in Example 1.

The Suds Stability (i.e., wash suds volume) and First Rinse Suds (i.e., rinse suds volume after ⅛ rinse) of each sample composition are tested using the Sudsing Profile Test described in Test 3.

The combined effect of the linear or branched unalkoxylated AS surfactant mixture and the cationic polymer on the Suds Stability (i.e., wash suds volume change in comparison with the control composition) is recorded and then compared with the effect of the linear or branched unalkoxylated AS surfactant mixture alone and the effect of the cationic polymer alone. Specifically, a Wash Suds Change (ΔS_{W}) is calculated for each comparative or inventive composition, which equals the Suds Stability measured for the respective comparative or inventive composition minus the Suds Stability measured for the control composition. A positive AS is indicative of a wash suds boosting effect, while a negative ΔS_{W} is indicative of a wash suds suppressing effect. The more positive the ΔS_{W}, the stronger the suds boosting effect.

The Wash Suds Change (ΔS_{W}) results are summarized in the table below:

TABLE III

| Sample or Test Formulation | ΔS_{W} |
|---|---|
| Base Detergent Composition (Control) | Ref = 0 |
| Base Detergent Composition + 3% Branched AS (Comparative) | 9.2 |
| Base Detergent Composition + 0.5% Polymer D (Comparative) | −9.1 |
| Base Detergent Composition + 0.5% Polymer D + 3% Branched AS (Inventive) | 3.3 |
| Base Detergent Composition + 3% Linear AS (Comparative) | 7.8 |
| Base Detergent Composition + 0.5% Polymer A (Comparative) | −14.0 |
| Base Detergent Composition + 0.5% Polymer A + 3% Linear AS (Inventive) | −0.8 |
| Base Detergent Composition + 3% Linear AS (Comparative) | 8.6 |
| Base Detergent Composition + 0.5% Polymer B (Comparative) | −12.1 |
| Base Detergent Composition + 0.5% Polymer B + 3% Linear AS (Inventive) | 3.2 |
| Base Detergent Composition + 3% Linear AS (Comparative) | 8.6 |
| Base Detergent Composition + 0.5% Polymer C (Comparative) | −14.4 |
| Base Detergent Composition + 0.5% Polymer C + 3% Linear AS (Inventive) | 3.7 |
| Base Detergent Composition + 3% Linear AS (Comparative) | 9.9 |
| Base Detergent Composition + 0.5% Polymer D (Comparative) | −11.9 |
| Base Detergent Composition + 0.5% Polymer D + 3% Linear AS (Inventive) | 2.7 |
| Base Detergent Composition + 3% Linear AS (Comparative) | 8.6 |
| Base Detergent Composition + 0.5% Polymer E (Comparative) | −11.6 |
| Base Detergent Composition + 0.5% Polymer E + 3% Linear AS (Inventive) | 1.8 |
| Base Detergent Composition + 3% Linear AS (Comparative) | 8.1 |
| Base Detergent Composition + 0.5% Polymer F (Comparative) | −8.3 |
| Base Detergent Composition + 0.5% Polymer F + 3% Linear AS (Inventive) | 3.0 |
| Base Detergent Composition + 3% Linear AS (Comparative) | 8.1 |
| Base Detergent Composition + 0.5% Polymer G (Comparative) | −7.1 |
| Base Detergent Composition + 0.5% Polymer G + 3% Linear AS (Inventive) | 5.3 |
| Base Detergent Composition + 3% Linear AS (Comparative) | 8.1 |
| Base Detergent Composition + 0.5% Polymer H (Comparative) | −5.5 |
| Base Detergent Composition + 0.5% Polymer H + 3% Linear AS (Inventive) | 5.5 |

It is evident that the ΔS_{W} of the inventive example containing both the linear/branched AS and the cationic polymer is more positive than the sum of the ΔS_{W} of the comparative example containing the linear/branched AS alone and the ΔS_{W} of the comparative example containing the cationic polymer alone. This indicates that combinations of the linear/branched AS and the cationic polymer have a synergistic suds boosting effect during the wash cycle.

The combined effect of the linear or branched unalkoxylated AS surfactant mixture and the cationic polymer on the First Rinse Suds (i.e., rinse suds volume change in comparison with the control composition) is recorded and then compared with the effect of the linear or branched unalkoxylated AS surfactant mixture alone and the effect of the cationic polymer alone. Specifically, a Rinse Suds Change (ΔS_{R}) is calculated for each comparative or inventive composition, which equals the Suds Stability measured for the respective comparative or inventive composition minus the Suds Stability measured for the control composition. A positive ΔS_{R} is indicative of more rinse suds, which is undesirable, while a negative ΔS_{W} is indicative of less rinse suds, which is desirable. The more negative the ΔS_{R}, the stronger the suds suppressing effect.

The Rinse Suds Change (ΔS_{R}) results are summarized in the table below:

TABLE IV

| Sample or Test Formulation | ΔS_{R} |
|---|---|
| Base Detergent Composition (Control) | Ref = 0 |
| Base Detergent Composition + 3% Branched AS (Comparative) | 5.4 |
| Base Detergent Composition + 0.5% Polymer D (Comparative) | −4.6 |
| Base Detergent Composition + 0.5% Polymer D + 3% Branched AS (Inventive) | −2.4 |
| Base Detergent Composition + 3% Linear AS (Comparative) | 4.0 |
| Base Detergent Composition + 0.5% Polymer A (Comparative) | −5.4 |
| Base Detergent Composition + 0.5% Polymer A + 3% Linear AS (Inventive) | −4.3 |
| Base Detergent Composition + 3% Linear AS (Comparative) | 4.1 |
| Base Detergent Composition + 0.5% Polymer B (Comparative) | −5.1 |
| Base Detergent Composition + 0.5% Polymer B + 3% Linear AS (Inventive) | −3.2 |
| Base Detergent Composition + 3% Linear AS (Comparative) | 4.1 |
| Base Detergent Composition + 0.5% Polymer C (Comparative) | −5.4 |
| Base Detergent Composition + 0.5% Polymer C + 3% Linear AS (Inventive) | −3.4 |
| Base Detergent Composition + 3% Linear AS (Comparative) | 4.4 |
| Base Detergent Composition + 0.5% Polymer D (Comparative) | −4.2 |
| Base Detergent Composition + 0.5% Polymer D + 3% Linear AS (Inventive) | −2.9 |
| Base Detergent Composition + 3% Linear AS (Comparative) | 4.1 |
| Base Detergent Composition + 0.5% Polymer E (Comparative) | −4.8 |
| Base Detergent Composition + 0.5% Polymer E + 3% Linear AS (Inventive) | −3.4 |
| Base Detergent Composition + 3% Linear AS (Comparative) | 4.8 |
| Base Detergent Composition + 0.5% Polymer F (Comparative) | −5.1 |
| Base Detergent Composition + 0.5% Polymer F + 3% Linear AS (Inventive) | −3.0 |
| Base Detergent Composition + 3% Linear AS (Comparative) | 4.8 |
| Base Detergent Composition + 0.5% Polymer G (Comparative) | −4.4 |
| Base Detergent Composition + 0.5% Polymer G + 3% Linear AS (Inventive) | −1.4 |
| Base Detergent Composition + 3% Linear AS (Comparative) | 4.8 |
| Base Detergent Composition + 0.5% Polymer H (Comparative) | −4.0 |
| Base Detergent Composition + 0.5% Polymer H + 3% Linear AS (Inventive) | −0.6 |

It is evident that the ΔS_{R} of the inventive example containing both the linear/branched AS and the cationic polymer is more negative than the sum of the ΔS_{W} of the comparative example containing the linear/branched AS alone and the ΔS_{W} of the comparative example containing the cationic polymer alone. This indicates that combinations of the linear/branched AS and the cationic polymer have a synergistic suppressing effect on the rinse suds volume.

Typically, a combination of two ingredients, one with a suds boosting effect and one with a suds suppressing effect, may demonstrate synergistic suds boosting effect both during the wash cycle and the rinse cycle, or it may demonstrate synergistic suds suppressing effect during the wash cycle and the rinse cycle. However, it is surprising and unexpected that the inventive combinations of the linear/branched AS surfactants and the cationic polymers of the present invention demonstrate a synergistic suds boosting effect during the wash cycle and simultaneously a synergistic suds suppressing effect during the rinse cycle.

### Example 5

### Exemplary Laundry Detergent Compositions

(A) Liquid Detergent Fabric Care Compositions: Liquid detergent fabric care composition 1A-1F are made by mixing together the ingredients listed in the proportions shown:

| Ingredient (wt %) | 1A | 1B | 1C | 1D | 1E | 1F |
|---|---|---|---|---|---|---|
| C₁₂-C₁₅ alkyl polyethoxylate (1-3) | 20.1 | 16.6 | 14.7 | 13.9 | 8.2 | 16.6 |
| sulfate¹ | | | | | | |
| C_{11.8} linear alkylbenzene sulfonic acid² | — | 4.9 | 4.3 | 4.1 | 8.2 | 4.9 |
| C₁₆-C₁₇ branched alkyl sulfate¹ | — | 2.0 | 1.8 | 1.6 | — | 2.0 |
| C₁₂ alkyl trimethyl ammonium | 2.0 | — | — | — | — | — |
| chloride⁴ | | | | | | |
| C₁₂ alkyl dimethyl amine oxide⁵ | — | 0.7 | 0.6 | — | — | 0.7 |
| C₁₂-C₁₄ alcohol 7 ethoxylate³ | 0-2 | 0-2 | 0-2 | 0-2 | 0-2 | 4 |
| C₁₅-C₁₆ branched alcohol 7 ethoxylate¹ | 0-2 | 0-2 | 0-2 | 0-2 | 0-2 | — |
| 1,2 Propane diol⁶ | 4.5 | 4.0 | 3.9 | 3.1 | 2.3 | 4.0 |
| Ethanol | 3.4 | 2.3 | 2.0 | 1.9 | 1.2 | 2.3 |
| C₁₂₋C₁₈ Fatty Acid⁵ | 0-4 | 0-4 | 0-4 | 0-4 | 0-4 | 0-4 |
| Citric acid⁷ | 3.4 | 3.2 | 3.5 | 2.7 | 3.9 | 3.2 |
| Protease⁷ (32 g/L) | 0.42 | 1.3 | 0.07 | 0.5 | 1.12 | 1.3 |
| Fluorescent Whitening Agent⁸ | 0.08 | 0.2 | 0.2 | 0.17 | 0.18 | 0.2 |
| Diethylenetriamine pentaacetic acid⁶ | 0.5 | 0.3 | 0.3 | 0.3 | 0.2 | 0.3 |
| Ethoxylated polyamine⁹ | 0.7 | 1.8 | 1.5 | 2.0 | 1.9 | 1.8 |
| Grease Cleaning Alkoxylated | — | — | 1.3 | 1.8 | — | — |
| Polyalkylenimine Polymer¹⁰ | | | | | | |
| Zwitterionic ethoxylated quaternized | — | 1.5 | — | — | 0.8 | 1.5 |
| sulfated hexamethylene diamine¹¹ | | | | | | |
| Hydrogenated castor oil¹² | 0.2 | 0.2 | | 0.12 | 0.3 | 0.2 |
| One or more of Polymers A-H | 0.1 | 0.5 | 3 | 0.1-3 | 0.1-3 | 0.5 |
| Linear AS of Example 2 | 1-5 | 1-5 | 1-5 | 1-5 | 0 | 1-5 |
| Branched AS of Example 3 | 0 | 0 | 0 | 1-5 | 1-5 | 0 |
| Water, perfumes, dyes, buffers, | to 100% | to 100% | to 100% | to 100% | to 100% | to 100% |
| solvents and other optional components | pH | pH | pH | pH | pH | pH |
| | 7.3-7.9 | 7.3-7.9 | 7.3-7.9 | 7.3-7.9 | 7.3-7.9 | 7.3-7.9 |

### (B): Liquid or Gel Detergents

Liquid or gel detergent fabric care compositions 2A-2E are prepared by mixing the ingredients listed in the proportions shown:

| Ingredient (wt %) | 2A | 2B | 2C | 2D | 2E |
|---|---|---|---|---|---|
| C₁₂-C₁₅ alkyl polyethoxylate (1-3) sulfate¹ | 8.5 | 2.9 | 2.9 | 2.9 | 6.8 |
| C_{11.8} linear alkylbenzene sulfonic acid² | 11.4 | 8.2 | 18.0 | 8.2 | 1.2 |
| C₁₄-C₁₅ alkyl 7-ethoxylate¹ | — | 1-5 | 1-5 | 1-5 | 3.0 |
| C₁₂-C₁₄ alkyl 7-ethoxylate³ | 7.6 | — | — | — | 1.0 |
| 1,2 Propane diol | 6.0 | 1.3 | 1.3 | 6.0 | 0.2 |
| Ethanol | — | 1.3 | 1.3 | — | 1.4 |
| Di Ethylene Glycol | 4.0 | — | — | — | — |
| Na Cumene Sulfonate | — | 1.0 | 1.0 | 0.9 | — |
| C₁₂-C₁₈ Fatty Acid⁵ | 9.5 | 0-4 | 0-4 | 0-4 | 0-4 |
| Citric acid | 2.8 | 3.4 | 3.4 | 3.4 | 2.4 |
| Protease (40.6 mg/g/)⁷ | 1.0 | 0.6 | 0.6 | 0.6 | 0.3 |
| Natalase 200 L (29.26 mg/g)¹³ | — | 0.1 | 0.1 | 0.1 | — |
| Termamyl Ultra (25.1 mg/g)¹³ | 0.7 | 0.1 | 0.1 | 0.1 | 0.1 |
| Mannaway 25 L (25 mg/g)¹³ | 0.1 | 0.1 | 0.1 | 0.1 | 0.02 |
| Whitezyme (20 mg/g)¹³ | 0.2 | 0.1 | 0.1 | 0.1 | — |
| Fluorescent Whitening Agent⁸ | 0.2 | 0.1 | 0.1 | 0.1 | — |
| Diethylene Triamine Penta Methylene | — | 0.3 | 0.3 | 0.3 | 0.1 |
| Phosphonic acid | | | | | |
| Hydroxy Ethylidene 1,1 Di Phosphonic | 1.5 | — | — | — | — |
| acid | | | | | |
| Zwitterionic ethoxylated quaternized | 2.1 | 1.0 | 1.0 | 1.0 | 0.7 |
| sulfated hexamethylene diamine¹¹ | | | | | |
| Grease Cleaning Alkoxylated | — | 0.4 | 0.4 | 0.4 | — |
| Polyalkylenimine Polymer¹⁰ | | | | | |
| PEG-PVAc Polymer¹⁴ | 0.9 | 0.5 | 0.5 | 0.5 | — |
| Hydrogenated castor oil¹² | 0.8 | 0.4 | 0.4 | 0.4 | 0.3 |
| Borate | — | 1.3 | — | — | 1.2 |
| 4 Formyl Phenyl Boronic Acid | — | — | 0.025 | — | — |
| One or more of Polymers A-H | 0.1 | 0.5 | 0.1-3 | 0.1-3 | 0.1-3 |
| Linear AS of Example 2 | 1-5 | 1-5 | 1-5 | 1-5 | 0 |
| Branched AS of Example 3 | 0 | 0 | 0 | 1-5 | 1-5 |
| Water, perfumes, dyes, buffers, | to | to | to | to | to |
| neutralizers, stabilizers and other optional | 100% | 100% | 100% | 100% | 100% |
| components | pH | pH | pH | pH | pH |
| | 8.0-8.2 | 8.0-8.2 | 8.0-8.2 | 8.0-8.2 | 8.0-8.2 |

¹Available from Shell Chemicals, Houston, TX.
²Available from Huntsman Chemicals, Salt Lake City, UT.
³Available from Sasol Chemicals, Johannesburg, South Africa
⁴Available from Evonik Corporation, Hopewell, VA.
⁵Available from The Procter & Gamble Company, Cincinnati, OH.
⁶Available from Sigma Aldrich chemicals, Milwaukee, WI
⁷Available from Genencor International, South San Francisco, CA.
⁸Available from Ciba Specialty Chemicals, High Point, NC
⁹600 g/mol molecular weight polyethylenimine core with 20 ethoxylate groups per —NH and available from BASF (Ludwigshafen, Germany)
¹⁰600 g/mol molecular weight polyethylenimine core with 24 ethoxylate groups per —NH and 16 propoxylate groups per —NH. Available from BASF (Ludwigshafen, Germany).
¹¹Described in WO 01/05874 and available from BASF (Ludwigshafen, Germany)
¹²Available under the tradename ThixinR from Elementis Specialties, Highstown, NJ
¹³Available from Novozymes, Copenhagen, Denmark.
¹⁴PEG-PVA graft copolymer is a polyvinyl acetate grafted polyethylene oxide copolymer available from BASF (Ludwigshafen, Germany), having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60.

### Example C

### Rinse-Added Fabric Care Compositions

Rinse-Added fabric care compositions 3A-3D are prepared by mixing together ingredients shown below:

| Ingredient | 3A | 3B | 3C | 3D |
|---|---|---|---|---|
| Fabric Softener Active¹ | 16.2 | 11.0 | 16.2 | — |
| Fabric Softener Active² | — | — | — | 5.0 |
| Cationic Starch³ | 1.5 | — | 1.5 | — |
| Polyethylene imine⁴ | 0.25 | 0.25 | — | — |
| Quaternized polyacrylamide⁵ | — | | 0.25 | 0.25 |
| Calcium chloride | 0.15 | 0. | 0.15 | — |
| Ammonium chloride | 0.1 | 0.1 | 0.1 | — |
| One or more of Polymers A-I | 0.1 | 0.5 | 0.1-3 | 0.1-3 |
| Linear AS of Example 2 | 1-5 | 1-5 | 1-5 | 0 |
| Branched AS of Example 3 | 0 | 0 | 1-5 | 1-5 |
| Perfume | 0.85 | 2.0 | 0.85 | 1.0 |
| Perfume microcapsule⁶ | 0.65 | 0.75 | 0.65 | 0.3 |
| Water, suds suppressor, stabilizers, pH | to 100% | to 100% | to 100% | to 100% |
| control agents, buffers, dyes & other | pH = 3.0 | pH = 3.0 | pH = 3.0 | pH = 3.0 |
| optional ingredients | | | | |

¹N,N di(tallowoyloxyethyl)-N,N dimethylammonium chloride available from Evonik Corporation, Hopewell, VA.
²Reaction product of fatty acid with Methyldiethanolamine, quaternized with Methylchloride, resulting in a 2.5:1 molar mixture of N,N-di(tallowoyloxyethyl) N,N-dimethylammonium chloride and N-(tallowoyloxyethyl) N-hydroxyethyl N,N-dimethylammonium chloride available from Evonik Corporation, Hopewell, VA.
³Cationic starch based on common maize starch or potato starch, containing 25% to 95% amylose and a degree of substitution of from 0.02 to 0.09, and having a viscosity measured as Water Fluidity having a value from 50 to 84. Available from National Starch, Bridgewater, NJ
⁴Available from Nippon Shokubai Company, Tokyo, Japan under the trade name Epomin ® 1050.
⁵Cationic polyacrylamide polymer such as a copolymer of acrylamide/[2-(acryloylamino)ethyl]tri-methylammonium chloride (quaternized dimethyl aminoethyl acrylate) available from BASF, AG, Ludwigshafen under the trade name Sedipur 544.
⁶Available from Appleton Paper of Appleton, WI

### Example D

### Powder Detergent Compositions

Powder detergent compositions 4A-4C are prepared by mixing together ingredients shown below:

| | 9A | 9B | 9C |
|---|---|---|---|
| Ingredient | wt % | wt % | wt % |
| LAS (Non-sulphated anionic | 10 | 15-16 | 7 |
| surfactant) | | | |
| Mixture of alkyl sulphate surfactants | 1.5 | 1.5-2 | 1.5 |
| Cationic surfactant | 0-1 | 0-1.5 | 0-1 |
| Non ionic surfactant | 0-1 | 0-1.5 | 0-1 |
| Zeolite | 0-3 | 6-10 | 0-3 |
| Polymeric dispersing or soil release | 1-3 | 1-4 | 1-3 |
| agents | | | |
| Bleach and bleach activator | 0-5 | 4-6 | 2-3 |
| Silicate | 7-9 | — | 5-6 |
| Carbonate | 10-30 | 25-35 | 15-30 |
| Sulfate | 30-70 | 30-35 | 40-70 |
| One or more of Polymers A-I | 0.1-3 | 0.1-3 | 0.1-3 |
| Linear AS of Example 2 | 1-5 | 1-5 | 0 |
| Branched AS of Example 3 | 0 | 1-5 | 1-5 |

| | |
|---|---|
| Deionized water | Balance to 100 wt % |

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising:
(a) one or more linear or branched C₆-C₁₈ alkyl sulphate (“AS”) surfactants, which comprise from 80% to 100% by weight of one or more linear or branched C₆-C₁₄ AS surfactants; and
(b) one or more cationic polymers comprising a cationic structural unit and having a cationic charge density ranging from 0.05 to 10 milliequivalents/g.

2. The cleaning composition of claim 1, wherein the one or more linear or branched C₆-C₁₈ AS surfactants are substantially free of alkoxylation, and preferably essentially free of alkoxylation.

3. The cleaning composition of claim 1, comprising a mixture of two or more linear AS surfactants that comprises (1) a linear C₁₂ AS surfactant in the amount ranging from 30% to 100%, preferably from 50% to 95%, and more preferably from 65% to 80%, by total weight of said mixture; (2) a linear C₁₄ AS surfactant in the amount ranging from 0% to 70%, preferably from 5% to 50%, and more preferably from 20% to 30%, by total weight of said mixture; and (3) a linear C₁₆ AS surfactant in the amount ranging from 0% to 30%, preferably from 1% to 20%, and more preferably from 4% to 10% by total weight of said mixture.

4. The cleaning composition of claim 3, wherein said mixture comprises less than 10%, preferably less than 5%, and more preferably less than 2% of linear AS surfactants having either 18 carbon atoms or more, or 10 carbon atoms or less, by total weight of said mixture.

5. The cleaning composition of claim 1, comprising one or more branched C₆-C₁₈ AS surfactants having the general formula (I): 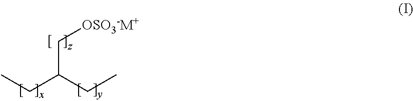
wherein M is a cation of alkali metal, alkaline earth metal or ammonium; x and y are independently selected from integers ranging from 0 to 14; wherein z is an integer ranging from 1 to 4; wherein the sum of x+y is equal to or greater than z; and wherein the sum of x+y+z ranges from 3 to 15.

6. The cleaning composition of claim 5, wherein z is 1, and wherein the sum of x+y is from 8 to 9.

7. The cleaning composition of claim 1, comprising a mixture of two or more branched AS surfactants that comprises (1) a branched C₁₂ AS surfactant in the amount ranging from 20% to 80%, preferably from 30% to 70%, and more preferably from 35% to 50%, by total weight of said mixture; and (2) a branched C₁₃ AS surfactant in the amount ranging from 20% to 80%, preferably from 30% to 70%, and more preferably from 35% to 50%, by total weight of said mixture.

8. The cleaning composition according to claim 1, wherein the one or more linear or branched C₆-C₁₈ AS surfactants are present in an amount ranging from 0.1% to 30%, preferably from 0.5% to 20%, and more preferably from 1% to 10%, by total weight of the cleaning composition.

9. The cleaning composition according to claim 1, wherein said one or more cationic polymers have a cationic charge density ranging from 0.1 to 5 milliequivalents/g, preferably from 0.3 to 4 milliequivalents/g, and more preferably from 0.6 to 3 milliequivalents/g.

10. The cleaning composition according to claim 1, wherein said one or more cationic polymers have a weight average molecular weight (Mw) ranging from 10,000 to 3,000,000 Daltons, preferably from 20,000 to 2,000,000 Daltons, more preferably from 30,000 to 1,500,000 Daltons, and most preferably from 40,000 to 200,000 Daltons.

11. The cleaning composition according to claim 1, wherein the cationic structural unit of the one or more cationic polymers are derived from a monomer selected from the group consisting of diallyl dimethyl ammonium salts (“DADMAS”), N,N-dimethyl aminoethyl acrylate, N,N-dimethyl aminoethyl methacrylate (“DMAM”), [2-(methacryloyl amino)ethyl]tri-methylammonium salts, N,N-dimethylaminopropyl acrylamide (DMAPA), N,N-dimethylaminopropyl methacrylamide (“DMAPMA”), acrylamidopropyl trimethyl ammonium salts (“APTAS”), methacrylamidopropyl trimethylammonium salts (“MAPTAS”), quaternized vinylimidazole (“QVi”), and combinations thereof, and preferably said cationic structural unit is derived from diallyl dimethyl ammonium chloride (“DADMAC”).

12. The cleaning composition of claim 11, wherein said one or more cationic polymers comprise 1 mol % to 100 mol %, preferably from 5 mol % to 100 mol %, more preferably from 5 mol % to 60 mol %, and most preferably from 5 mol % to 20 mol %, of said cationic structural unit.

13. The cleaning composition according to claim 1, wherein said one or more cationic polymers comprise a first nonionic structural unit derived from (meth)acrylamide (“AAm”), which is preferably present in said one or more cationic polymers in an amount ranging from 0 mol % to 99 mol %, preferably from 10 mol % to 95 mol %, and more preferably from 15 mol % to 90 mol %.

14. The cleaning composition of claim 13, wherein said one or more cationic polymers further comprise a second nonionic structural unit derived from a monomer selected from the group consisting of vinylpyrrolidone (“VP”), vinyl acetate, vinyl alcohol, vinyl formamide, vinyl acetamide, vinyl alkyl ether, vinyl pyridine, vinyl imidazole, vinyl caprolactam, and combinations thereof, and wherein said second nonionic structural unit is preferably VP.

15. The cleaning composition of claim 14, wherein said one or more cationic polymers comprises from 0 mol % to 50 mol %, preferably from 0 mol % to 30 mol %, and more preferably from 5 mol % to 25 mol %, of said second nonionic structural unit.

16. The cleaning composition according to claim 1, wherein said cationic polymer is present in an amount ranging from 0.01% to 20%, preferably from 0.05% to 10%, more preferably from 0.1% to 5%, and most preferably from 0.2% to 4% by total weight of the cleaning composition.

17. The cleaning composition according to claim 1, further comprising one or more additional surfactants selected from the group consisting of anionic surfactants, nonionic surfactants, cationic surfactants, amphoteric surfactants, zwitterionic surfactants, and combinations thereof.

18. The cleaning composition of claim 17, wherein said additional surfactants comprise: (1) from 1% to 90% by weight of one or more anionic surfactants selected from the group consisting of C₁₀-C₂₀ linear alkyl benzene sulphonates, C₁₀-C₂₀ linear or branched alkylalkoxy sulfates having an average degree of alkoxylation ranging from 0.1 to 5.0, C₁₀-C₂₀ linear or branched alkyl sulphonates, C₁₀-C₂₀ linear or branched alkyl phosphates, C₁₀-C₂₀ linear or branched alkyl phosphonates, C₁₀-C₂₀ linear or branched alkyl carboxylates, and combinations thereof; and (2) optionally, from 0.05% to 10% by weight of one or more nonionic surfactants selected from the group consisting of C₈-C₁₈ alkyl alkoxylated alcohols having a weight average degree of alkoxylation ranging from 1 to 20 and combinations thereof.

19. The cleaning composition according to claim 1, which is preferably a granular or liquid laundry detergent composition, and more preferably a liquid laundry detergent composition.

20. A liquid laundry detergent composition comprising:
(a) from 0.5% to 5% by weight of a linear C₁₂ AS surfactant;
(b) from 0.1% to 2% by weight of a linear C₁₄ AS surfactant;
(c) from 0.05% to 1% by weight of a linear C₁₆ AS surfactant;
(d) from 0.1% to 2% by weight of a cationic polymer which is a copolymer or terpolymer containing a first cationic structural unit derived from DADMAC, MAPTAC, APTAC or QVi, a second nonionic structural unit derived from AAm, and optionally a third nonionic structural unit derived from VP;
(e) from 5% to 20% by weight of C₁₀-C₂₀ linear alkyl benzene sulphonates; and
(f) from 1% to 10% by weight of C₁₀-C₁₄ alkyl alkoxylated alcohols having a weight average degree of alkoxylation ranging from 5 to 10 and combinations thereof.

21. A liquid laundry detergent composition comprising:
(a) from 0.5% to 5% of a branched C₁₂ AS surfactant;
(b) from 0.5% to 5% of a branched C₁₃ AS surfactant; and
(c) from 0.1% to 2% by weight of a cationic polymer which is a copolymer or terpolymer containing a first cationic structural unit derived from DADMAC, MAPTAC, APTAC or QVi, a second nonionic structural unit derived from AAm, and optionally a third nonionic structural unit derived from VP;
(g) from 5% to 20% by weight of C₁₀-C₂₀ linear alkyl benzene sulphonates; and
(h) from 1% to 10% by weight of C₁₀-C₁₄ alkyl alkoxylated alcohols having a weight average degree of alkoxylation ranging from 5 to 10 and combinations thereof.

22. Use of the cleaning or liquid laundry detergent composition according to claim 1 for hand-washing fabrics to achieve improved sudsing profile during.

23. The use according to claim 22, wherein the fabric is rinsed no more than twice, preferably no more than once, after wash.
